(19) United States
(12) Patent Application Publication
(10) Pub. No.: US 2015/0261034 A1
(43) Pub. Date: Sep. 17, 2015

(54) DISPLAY APPARATUS

(71) Applicant: Panasonic Intellectual Property Management Co., Ltd., Osaka (JP)

(72) Inventors: Tatsuya KOYAMA, Osaka (JP); Kaname TOMITA, Osaka (JP); Masashi FUJIMOTO, Osaka (JP)

(21) Appl. No.: 14/657,745

(22) Filed: Mar. 13, 2015

(30) Foreign Application Priority Data
Mar. 14, 2014 (JP) 2014-051521
Dec. 5, 2014 (JP) 2014-246721

(51) Int. Cl. G02F 1/1333; G06F 1/16

(52) U.S. Cl. CPC G02F 1/133308; G02F 1/13338; G06F 1/1601; G02F 2001/133314

(57) ABSTRACT

A display apparatus includes a display unit and an exterior frame. The exterior frame is so provided as to cover a back side of the display unit. The exterior frame includes a first surface so disposed as to extend substantially in parallel with a display screen of the display unit, a second surface extended in a such a direction as to cross the first surface and so provided as to surround an outer circumference of the first surface, and a recessed portion formed by the first surface and the second surface into an area recessed as viewed from the back side of the display unit.

### BACKGROUND

1. Field

The present disclosure relates to a display apparatus provided with an exterior frame which covers a back side of the display apparatus.

2. Description of the Related Art

Unexamined Japanese Patent Publication No. 2010-256586 discloses a technology which increases mechanical strength of a back metal plate of a backlight device included in a liquid crystal module of a video display apparatus without affecting reduction of a thickness and a weight of the video display apparatus.

### SUMMARY

A display apparatus according to the present disclosure includes a display unit that displays various types of data, and an exterior frame. The exterior frame is so provided as to cover a back side of the display unit. The exterior frame includes a first surface so disposed as to extend substantially in parallel with a display screen of the display unit, a second surface extended in a such a direction as to cross the first surface and so provided as to surround an outer circumference of the first surface, and a recessed portion formed by the first surface and the second surface into an area recessed as viewed from the back side of the display unit.

### BRIEF DESCRIPTION OF DRAWINGS

FIG. 1 is a back view illustrating a configuration of a display apparatus according to a first exemplary embodiment of the present disclosure;

FIG. 2 is a cross-sectional view taken along line X-X in FIG. 1 as viewed in a direction of arrows;

FIG. 3 is a cross-sectional view illustrating a recessed portion formed on a back side of the display apparatus illustrated in FIG. 1, showing a state where an electronic substrate and a cover member are attached to the recessed portion; and

FIG. 4 is a cross-sectional view illustrating a configuration of a display apparatus according to another exemplary embodiment of the present disclosure.

### DETAILED DESCRIPTION

Exemplary embodiments are hereinafter described in detail with reference to the drawings as necessary. In the following description, excessively detailed explanation may be omitted depending on situations. For example, description concerning details of matters already well known, or repeated description for substantially identical configurations may be omitted. These omissions are made for avoiding unnecessary redundancy in the following description, and helping those skilled in the art easily understand the description.

The accompanying drawings and the following description are presented only for the purpose of helping those skilled in the art sufficiently understand the present technology, and therefore are not intended to limit the subject matters of the appended claims in any way.

### First Exemplary Embodiment

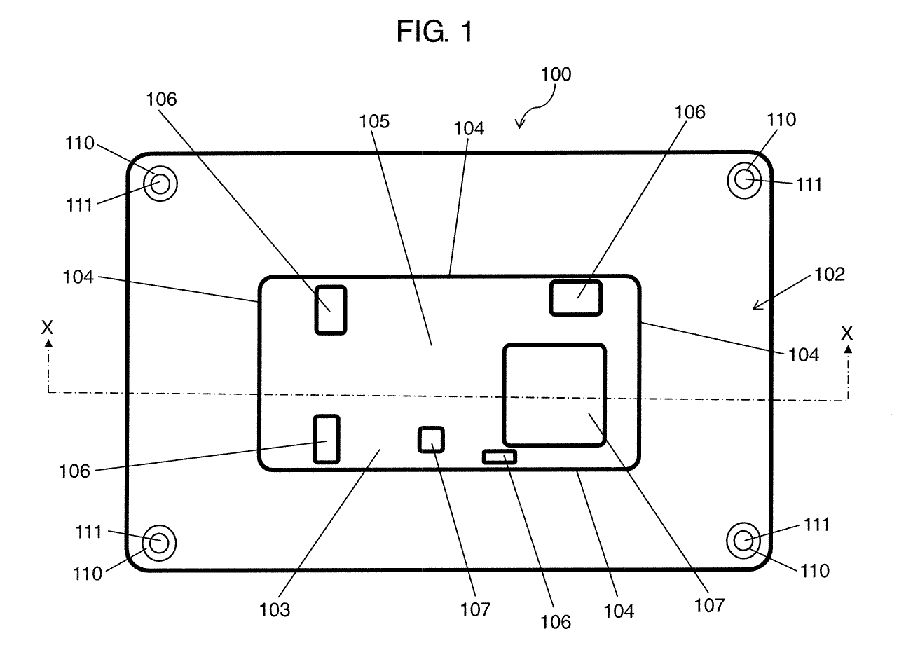

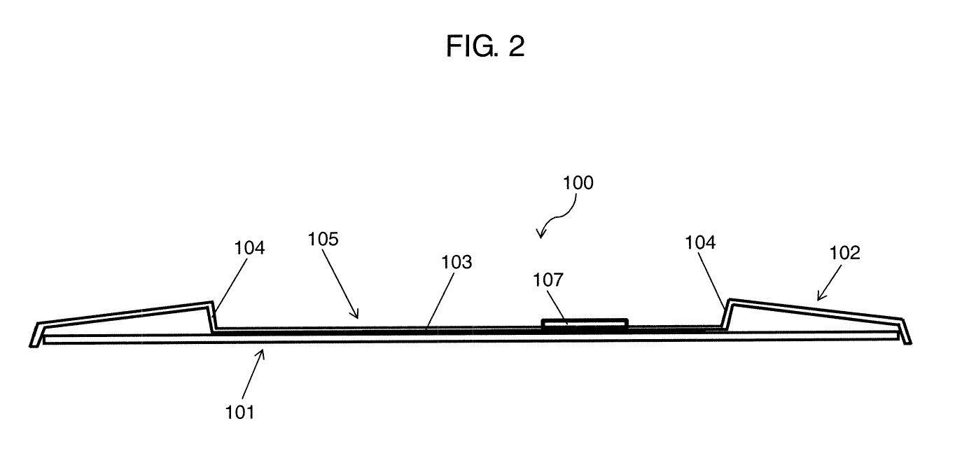

A display apparatus according to an exemplary embodiment of the present disclosure is now described with reference to FIGS. 1 and 2.

### [1-1. Configuration]

FIG. 1 is a back view of display apparatus 100 according to a first exemplary embodiment. FIG. 2 is a cross-sectional view of display apparatus 100 taken along line X-X as viewed in a direction of arrows.

As illustrated in FIGS. 1 and 2, display apparatus 100 includes display unit 101 and exterior frame 102.

Display unit 101 is a touch panel type liquid crystal display panel equipped with a glass substrate on a front surface of display unit 101. Display unit 101 displays a video image based on video data processed by a graphic controller (not shown). Display unit 101 further displays various types of information including character information, image information and the like.

Exterior frame 102 is made of aluminum, for example. As illustrated in FIG. 2, exterior frame 102 is so disposed as to cover a back side of display unit 101, constituting a back of display apparatus 100.

Exterior frame 102 has first surface 103 extending substantially in parallel with a display screen of display unit 101, and second surfaces 104 so erected as to surround an outer circumference of first surface 103.

As illustrated in FIG. 1, first surface 103 is positioned substantially at a center of a back side of exterior frame 102, constituting a bottom surface of recessed portion 105 (described later). As illustrated in FIG. 1, first surface 103 has a plurality of holes 106, and a plurality of projection portions 107.

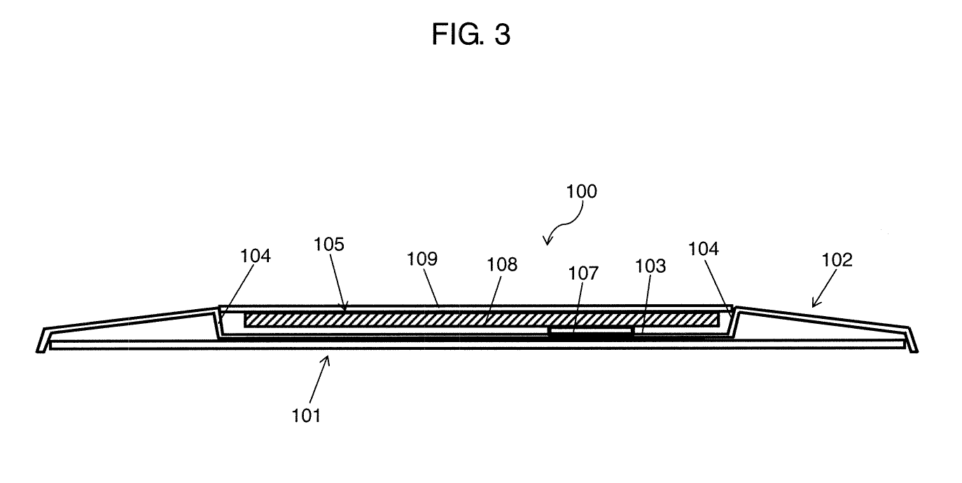

The plurality of holes 106 are holes through which cables are inserted for connection between display unit 101 and electronic substrate 108 (described later) (see FIG. 3).

The plurality of projection portions 107 are components equipped for adjustment of a distance to electronic parts on electronic substrate 108 (described later), and for contact with heat dissipation rubber, heat dissipation gel or the like (not shown), providing a function of dissipating heat generated from the electronic parts.

Second surfaces 104, positioned on a side opposite to a plane facing to display unit 101, are constituted by four surfaces surrounding four sides of first surface 103. As illustrated in FIG. 2, second surfaces 104 are extended in directions crossing first surface 103 for each.

According to the first exemplary embodiment, each angle of crossing portions as connections between first surface 103 and second surfaces 104 is set in a range from 97 degrees to 100 degrees to first surface 103. It is preferable that each angle of the crossing portions as connections between first surface 103 and second surfaces 104 is set to 90 degrees so as to further increase strength of exterior frame 102.

According to this structure, second surfaces 104 are erected from the four sides of the outer circumference of first surface 103 substantially at 90 degrees, and therefore are capable of supporting an external force received by a front (display screen side) of first surface 103 (display unit 101). In this case, the external force applied to the front of display unit 101 is received by first surface 103 disposed substantially in contact with the back side of display unit 101, and also the external force received by first surface 103 is supported by second surfaces 104.

Accordingly, this structure can prevent distortion of display unit 101 which may be caused when an external force is applied to the front of display unit 101.

In addition, there is provided recessed portion 105 located substantially at a central portion of exterior frame 102, which portion 105 is an area formed by first surface 103 and four second surfaces 104 extended in directions crossing first surface 103.

As illustrated in FIGS. 2 and 3, recessed portion 105 positioned on the back side of display apparatus 100 is formed into an area recessed as viewed from the back side. Recessed portion 105 accommodates electronic substrate 108 provided for controlling display apparatus 100. Recessed portion 105 in a state accommodating electronic substrate 108 within an inner space of recessed portion 105 is covered by cover member 109.

As illustrated in FIG. 1, recessed portion 105 is disposed at a position corresponding to a substantially central portion of display unit 101 as viewed from the back side of display apparatus 100. As illustrated in FIG. 2, recessed portion 105 is disposed opposite to the back of display unit 101 in such a condition as to produce substantially no clearance between recessed portion 105 and the back of display unit 101 as viewed in the cross-sectional view.

According to this structure, the central portion of display unit 101 producing a largest amount of distortion is supported from the back side even when an external force is applied to the front of display unit 101. In this case, the amount of distortion of display unit 101 becomes substantially zero, so that problems such as breakage of display unit 101 are prevented.

There are further provided screw holes 110 at four corners of the back side of exterior frame 102 as illustrated in FIG. 1. Exterior frame 102 is fixed to the back side of display unit 101 by threading four screws 111 into corresponding screw holes 110.

Positions and a number of screw holes 110 are not limited to these specific examples. The positions and number of screw holes 110 may be appropriately varied in accordance with a shape and other conditions of exterior frame 102.

[1-2. Operation for Coping with External Force Applied to Display Screen]

Discussed hereinbelow are operations of first surface 103 and second surfaces 104 performed when an external force is applied to the display screen of display unit 101 of display apparatus 100.

In case of a display apparatus functioning as a seat monitor provided inside an airplane, for example, a front side of the display apparatus corresponds to a surface exposed to a user. Accordingly, a predetermined level of durability against an external force applied to a display screen is required for this type of display apparatus.

According to display apparatus 100 in the first exemplary embodiment, sufficient durability is secured by the use of a following mechanism even when an external force is applied to the display screen as in this situation.

More specifically, when an external force is applied to the display screen of display unit 101, display unit 101 is distorted in a direction opposite to a front direction of the display screen.

As a result, the back side of display unit 101 contacts first surface 103 of exterior frame 102. In this case, the force is dispersed in a direction parallel with first surface 103 in the condition of contact between the surfaces of first surface 103 and the back side of display unit 101.

The force dispersed along first surface 103 is transmitted toward second surfaces 104 erected to cover an outer circumferential portion of first surface 103.

In this case, second surfaces 104 receive the force in directions substantially perpendicular to flat surfaces of second surfaces 104, so that exterior frame 102 is not easily distorted.

Accordingly, even when an external force such as shock and vibration is applied to display apparatus 100 from the outside, this force is dispersed by the structure of exterior frame 102. Thus, breakage or the like of display apparatus 100 is avoidable.

### [1-3. Advantageous Effects and Others]

As described above, display apparatus 100 according to the first exemplary embodiment includes exterior frame 102 and display unit 101. Exterior frame 102 includes first surface 103 so disposed as to extend substantially in parallel with the back of display unit 101. Exterior frame 102 further includes second surfaces 104 erected to extend in such directions as to cross first surface 103 and so provided as to surround the outside circumferential portion of first surface 103.

According to this configuration, distortion of display unit 101 is prevented by the structure of exterior frame 102 even when shock, vibration or the like is applied to display unit 101. Accordingly, prevention of breakage of display unit 101 is effectively achievable.

Particularly, recessed portion 105 is disposed substantially at the central portion of the back side of display unit 101 in such a condition as to produce substantially no clearance between recessed portion 105 and display unit 101. This structure reduces distortion of display unit 101 to the minimum, thereby effectively preventing breakage of display unit 101.

Moreover, breakage of electronic substrate 108 is similarly avoidable in a structure where electronic substrate 108 is accommodated within recessed portion 105 as illustrated in FIG. 3.

### Other Exemplary Embodiments

The first exemplary embodiment has been described herein as an example of a technology disclosed in the present application. However, the technology according to the present disclosure is not limited to this example, but may be applied to exemplary embodiments including modifications, replacements, additions, omissions and others. In addition, respective constituent elements described in the foregoing first exemplary embodiment may be combined to present different exemplary embodiments.

### (A)

According to the exemplary embodiment discussed herein as a specific configuration example, electronic substrate 108 is disposed within recessed portion 105 formed on the back side of exterior frame 102. However, the present disclosure is not limited to this example.

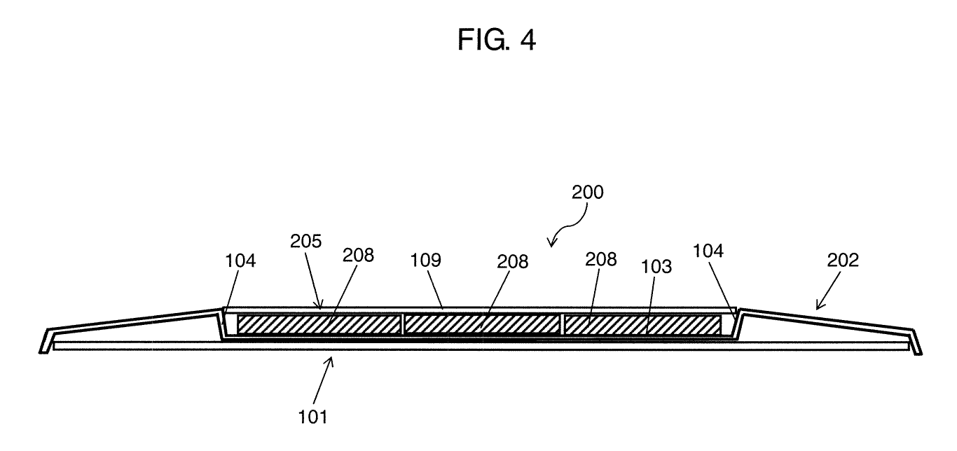

For example, there may be provided exterior frame 202 containing a plurality of batteries 208 within recessed portion 205 as illustrated in FIG. 4.

In this case, the back side of display unit 101 is supported by recessed portion 205 accommodating batteries 208. Accordingly, advantageous effects similar to the advantageous effects of the foregoing first exemplary embodiment are offered even when an external force is applied to display apparatus 200.

When the plurality of batteries 208 are accommodated within recessed portion 205 as illustrated in FIG. 4, an electronic substrate may be positioned either outside recessed portion 205, or inside recessed portion 205 together with the batteries.

### (B)

According to the exemplary embodiment discussed herein as a specific example, exterior frame 102 is made of aluminum. However, the present disclosure is not limited to this example.

Exterior frame 102 may be made of metal material such as stainless steel, for example. In other words, exterior frame 102 is made of material selected as an optimum material n consideration of processing method, cost, strength and other conditions of exterior frame 102.

### (C)

According to the exemplary embodiment discussed herein as a specific example, exterior frame 102 is fixed to the back side of display unit 101 by fastening of screws 111. However, the present disclosure is not limited to this example.

Examples of the method for fixing the exterior frame to the back side of the display unit include engagement, adhesion, and other methods as well as screw fastening.

### (D)

According to the exemplary embodiment discussed herein as a specific example, display unit 101 is constituted by a touch panel type liquid crystal display panel. However, the present disclosure is not limited to this example.

Display unit 101 may be constituted by an ordinary display panel not providing touch panel function.

The present disclosure is applicable to display apparatus of a wide variety of types requiring sufficient rigidity against an external force applied to a display screen. Specific examples of display apparatus to which the present disclosure is applicable involve a seat monitor provided within an airplane, a television set, and a smartphone.

What is claimed is:

1. A display apparatus comprising:
a display unit that displays various types of data;
an exterior frame that includes a first surface so provided as to cover a back side of the display unit, and so disposed as to extend substantially in parallel with a display screen of the display unit, a second surface extended in a such a direction as to cross the first surface and so provided as to surround an outer circumference of the first surface, and a recessed portion formed by the first surface and the second surface into an area recessed as viewed from the back side of the display unit.

2. The display apparatus according to claim 1, wherein the recessed portion is disposed opposite to a central portion of the display unit.

3. The display apparatus according to claim 1 further comprising an electronic substrate fixed to the recessed portion.

4. The display apparatus according to claim 1 further comprising a battery fixed to the recessed portion.

5. The display apparatus according to claim 1, wherein a plurality of holes and a plurality of projection portions are formed in the first surface that forms the recessed portion.

6. An exterior frame so provided as to cover a back side of a display unit that displays various types of data, the exterior frame comprising:
a first surface so disposed as to extend substantially in parallel with a display screen of the display unit;
a second surface extended in a such a direction as to cross the first surface and so provided as to surround an outer circumference of the first surface; and
a recessed portion formed by the first surface and the second surface into an area recessed as viewed from the back side of the display unit.
